(19) United States
(12) Patent Application Publication
(10) Pub. No.: US 2025/0386301 A1
(43) Pub. Date: Dec. 18, 2025

(54) METHOD FOR PERFORMING TRANSMISSION POWER MANAGEMENT OF WIRELESS TRANSCEIVER DEVICE WITHIN WIRELESS COMMUNICATION SYSTEM WITH AID OF PACKET-ERROR-RATE-BASED TRANSMITTED POWER TRIAL, AND ASSOCIATED APPARATUS

(71) Applicant: MEDIATEK INC., Hsinchu City (TW)

(72) Inventors: Wei-Chen Wang, Hsinchu City (TW); Ching-Yu Kuo, Hsinchu City (TW)

(73) Assignee: MEDIATEK INC., Hsinchu City (TW)

(21) Appl. No.: 19/218,646

(22) Filed: May 27, 2025

Related U.S. Application Data
(60) Provisional application No. 63/659,963, filed on Jun. 14, 2024.

(51) Int. Cl. H04W 52/20

(52) U.S. Cl. CPC H04W 52/20

(57) ABSTRACT

A method for performing transmission power management of a wireless transceiver device within a wireless communication system with aid of packet-error-rate-based (PER-based) transmitted power trial and associated apparatus are provided. The method may include: transmitting at least one first packet with at least one first transmitted power from the wireless transceiver device to another device, for monitoring at least one packet error rate (PER) of the at least one first packet at the other device; and transmitting a second packet with a second transmitted power from the wireless transceiver device to the other device based on a PER detection result, the PER detection result comprising any PER among the at least one PER of the at least one first packet.

### CROSS REFERENCE TO RELATED APPLICATIONS

This application claims the benefit of U.S. Provisional Application No. 63/659,963, filed on Jun. 14, 2024. The content of the application is incorporated herein by reference.

### BACKGROUND

The present invention is related to wireless devices, and more particularly, to a method for performing transmission power management of a wireless transceiver device within a wireless communication system with aid of packet-error-rate-based (PER-based) transmitted power trial, and associated apparatus such as a station (STA) device.

According to the related art, a wireless communication device in a wireless local area network (WLAN) may communicate with another wireless communication device via packet transmission and packet reception, but the pre-defined or fixed transmitted power is typically not optimal setting for all kinds of user scenarios. It seems that there is no proper solution in the related art. Thus, a novel method and associated architecture are needed for solving the problem without introducing any side effect or in a way that is less likely to introduce a side effect.

### SUMMARY

It is an objective of the present invention to provide a method for performing transmission power management of a wireless transceiver device within a wireless communication system with aid of PER-based transmitted power trial, and associated apparatus such as an access point (AP) device, a non-access-point (non-AP) STA device, etc., in order to solve the above-mentioned problem.

At least one embodiment of the present invention provides a method for performing transmission power management of a wireless transceiver device within a wireless communication system with aid of PER-based transmitted power trial. For example, the method may comprise: transmitting at least one first packet with at least one first transmitted power from the wireless transceiver device to another device, for monitoring at least one packet error rate (PER) of the at least one first packet at the other device; and transmitting a second packet with a second transmitted power from the wireless transceiver device to the other device based on a PER detection result, the PER detection result comprising any PER among the at least one PER of the at least one first packet.

At least one embodiment of the present invention provides a wireless transceiver device for performing transmission power management of the wireless transceiver device within a wireless communication system with aid of PER-based transmitted power trial. The wireless transceiver device may comprise a processing circuit that is arranged to control operations of the wireless transceiver device. The wireless transceiver device may further comprise at least one communication control circuit that is coupled to the processing circuit and arranged to perform communication control, wherein the at least one communication control circuit is arranged to perform wireless communication operations for the wireless transceiver device. For example, the wireless transceiver device is arranged to transmit at least one first packet with at least one first transmitted power from the wireless transceiver device to another device, for monitoring at least one PER of the at least one first packet at the other device; and the wireless transceiver device is arranged to transmit a second packet with a second transmitted power from the wireless transceiver device to the other device based on a PER detection result, the PER detection result comprising any PER among the at least one PER of the at least one first packet.

According to some embodiments, the apparatus may comprise at least one portion (e.g., a portion or all) of the wireless communication system. For example, the apparatus may represent a portion of the wireless communication system, such as the wireless transceiver device (e.g., an AP device or a non-AP STA device). In some examples, the apparatus may represent the whole of the wireless communication system.

It is an advantage of the present invention that the method of the present invention, as well as the associated apparatus such as the wireless transceiver device, can optimize the transmitted power in all kinds of scenarios by applying PER-based transmitted power trial. For example, regarding coverage extension, the wireless transceiver device operating according to the method can determine the transmitted power with sufficient error vector magnitude (EVM) to maintain high data rate transmission. For wireless communication, higher transmitted power can raise the receiver signal strength to benefit signal demodulation. However, higher transmitted power may lower signal EVM due to radio frequency (RF) circuit characteristic, and the transmitted signal's EVM degradation may offset the benefits of increasing transmitted power. As the EVM requirements of different channel types, attenuations, receiver devices, and data modulations are typically different from each other, how to determine the optimal transmitted power with sufficient EVM is a problem. The wireless transceiver device operating according to the method can transmit signals with different transmitted power based on PER detection results, and therefore can perform coverage extension with ease, having no concern like such problem. In addition, regarding low power consumption, the wireless transceiver device operating according to the method can lower the transmitted power with sufficient signal-to-noise ratio (SNR) to keep identical data rate. The required SNR of receiving a specific data rate is typically fixed, and high transmitted power may deliver excessive SNR and results in high power consumption. Adopting low transmitted power with sufficient SNR for receiving a specific data rate can lower the transmitted power consumption. However, the sufficient SNRs of receiving a specific data rate are typically different for different channels, attenuations, receiver devices, and data modulations, so how to determine the lower transmitted power with sufficient SNR is a problem. The wireless transceiver device operating according to the method can transmit signals with different transmitted power based on PER detection results, and therefore can lower the power consumption with ease, having no concern like such problem. Additionally, the method of the present invention and the associated apparatus can solve the related art problem without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 illustrates, in the lower half part thereof, a PER-based transmission power control scheme of a method for performing transmission power management of a wireless transceiver device within a wireless communication system with aid of PER-based transmitted power trial according to an embodiment of the present invention, where an EVM-based transmission power control scheme may be illustrated in the upper half part of FIG. 2 for better comprehension.

FIG. 3 illustrates a coverage extension control scheme of the method according to an embodiment of the present invention.

FIG. 4 illustrates, in the lower half part thereof, some implementation details of the coverage extension control scheme shown in FIG. 3 according to an embodiment of the present invention, where an example related to the EVM-based transmission power control scheme may be illustrated in the upper half part of FIG. 4 for better comprehension.

FIG. 5 illustrates a power consumption lowering control scheme of the method according to an embodiment of the present invention.

FIG. 6 illustrates, in the lower half part thereof, some implementation details of the power consumption lowering control scheme shown in FIG. 5 according to an embodiment of the present invention, where an example related to the EVM-based transmission power control scheme may be illustrated in the upper half part of FIG. 6 for better comprehension.

FIG. 7 illustrates a main working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

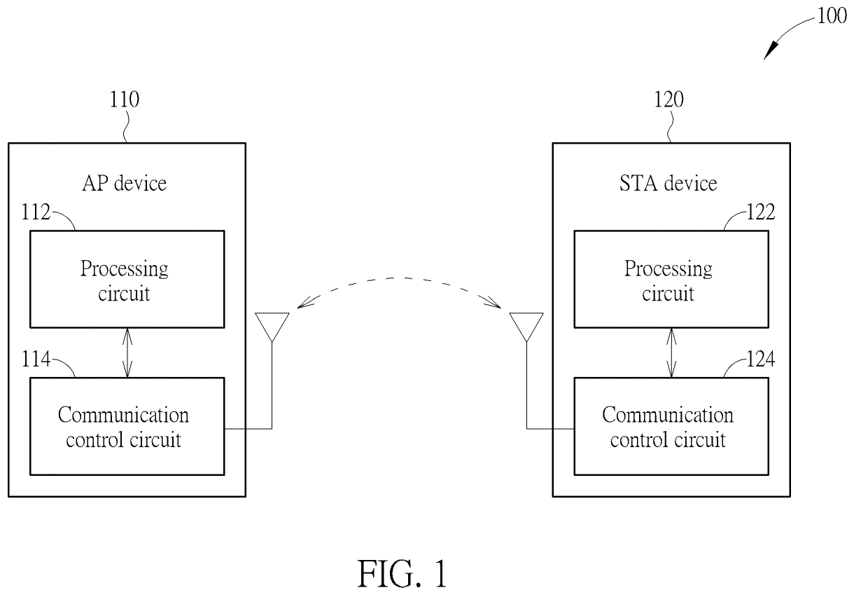

FIG. 1 is a diagram of a wireless communication system 100 according to an embodiment of the present invention. For better comprehension, the wireless communication system 100, as well as any wireless transceiver device therein, may be compatible or backward compatible to one or more versions of the Institute of Electrical and Electronics Engineers (IEEE) 802.11 standards, but the present invention is not limited thereto. The wireless communication system 100 may comprise multiple wireless transceiver devices. As shown in FIG. 1, the multiple wireless transceiver devices within the wireless communication system 100 may comprise the AP device 110 and the STA device 120, where the AP device 110 may comprise a processing circuit 112, at least one communication control circuit (e.g., one or more communication control circuits), which may be collectively referred to as the communication control circuit 114, and at least one antenna (e.g., one or more antennas) of the communication control circuit 114, and the STA device 120 may comprise a processing circuit 122, at least one communication control circuit (e.g., one or more communication control circuits), which may be collectively referred to as the communication control circuit 124, and at least one antenna (e.g., one or more antennas) of the communication control circuit 124.

In the architecture shown in FIG. 1, the processing circuit 112 can be arranged to control operations of the AP device 110 to make the AP device 110 act as at least one AP in the wireless communication system 100, such as multiple APs integrated into the AP device 110, and the communication control circuit 114 can be arranged to perform communication control, and more particularly, perform wireless communication operations with the STA device 120 (or the communication control circuit 124 thereof) for the AP device 110. In addition, the processing circuit 122 can be arranged to control operations of the STA device 120 to make the STA device 120 act as at least one STA in the wireless communication system 100, such as multiple STAs integrated into the STA device 120, and the communication control circuit 124 can be arranged to perform communication control, and more particularly, perform wireless communication operations with the AP device 110 (or the communication control circuit 114 thereof) for the STA device 120.

According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the AP device 110 may include, but are not limited to: a Wi-Fi router. In addition, the processing circuit 122 can be implemented by way of at least one processor/microprocessor, at least one RAM, at least one bus, etc., and the communication control circuit 124 can be implemented by way of at least one wireless network control circuit, but the present invention is not limited thereto. Examples of the STA device 120 may include, but are not limited to: a multifunctional mobile phone, a laptop computer, an all-in-one computer and a wearable device.

As shown in FIG. 1, the multiple wireless transceiver devices within the wireless communication system 100 may comprise the AP device 110 and the STA device 120. This is for illustrative purposes only, and is not meant to be a limitation of the present invention. According to some embodiments, the multiple wireless transceiver devices within the wireless communication system 100 may be implemented by way of multiple multi-link devices (MLDs).

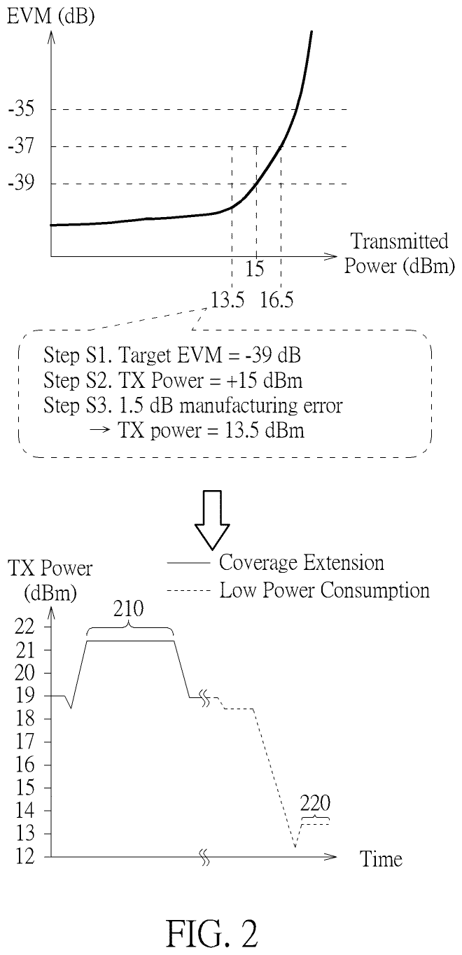

FIG. 2 illustrates, in the lower half part thereof, a PER-based transmission power control scheme of a method for performing transmission power management of a wireless transceiver device within a wireless communication system (e.g., the aforementioned any wireless transceiver device within the wireless communication system 100, such as the AP device 110 or the STA device 120 like a non-AP STA device) with aid of PER-based transmitted power trial according to an embodiment of the present invention, where an EVM-based transmission power control scheme may be illustrated in the upper half part of FIG. 2 for better comprehension. Assume that one or more functions of the wireless communication system 100 may be temporarily disabled to allow the AP device 110 and the STA device 120 to operate according to the EVM-based transmission power control scheme shown in the upper half part of FIG. 2, but the present invention is not limited thereto. Based on the EVM-based transmission power control scheme, the associated operations of a transmitted power determination flow may comprise:
(1) in Step S1, a target EVM may be determined as the worst EVM requirement of all supported scenarios and regulations, such as −39 decibel (dB) in this example (labeled “Target EVM=−39 dB” for brevity);
(2) in Step S2, a maximum transmitted/transmission power (TX power) satisfying the target EVM may be determined according to the RF circuit performance such as that illustrated with the curve shown in the upper half part of FIG. 2, and more particularly, may be determined as +15 decibel-milliwatts (dBm) according to this curve (labeled “TX Power=+15 dBm” for brevity); and
(3) in Step S3, the transmitted power may be downward adjusted with considering the manufacturing error such as an error of 1.5 dB (labeled “1.5 dB manufacturing error” for brevity), and more particularly, may be downward adjusted to 13.5 dBm (labeled “TX power=13.5 dBm” for brevity).
where the transmitted power margin is fixed after the transmitted power determination flow. In some good channel conditions and good chips, such transmitted power margins are not necessary.

TABLE 1

| Condition | EVM Requirement |
|---|---|
| IEEE SPEC | −35 dB |
| Conducted Test | −37 dB |
| Radiated Test | −39 dB |

Table 1 illustrates an example of the respective EVM Requirements of some conditions, where the conditions may comprise a first condition of the IEEE 802.11 standards or specification (referred to as “the IEEE SPEC” hereinafter), a second condition of a conducted test, and a third condition of a radiated test. As mentioned above, the target EVM may be determined as the worst EVM requirement of all supported scenarios and regulations, such as −39 dB. After the transmitted power determination flow, the transmitted power may be determined as 13.5 dBm. However, for good chip in the conducted test, 16.5 dBm is available, which means a 3 dB gain exists.

Although the transmitted data rate can be improved by raising the transmitted power, it is needed to determine if the present channel or chips require these transmitted power margins. Based on the PER-based transmission power control scheme, the aforementioned any wireless transceiver device (e.g., the AP device 110 or the STA device 120 such as the non-AP STA device) can optimize the transmitted power in all kinds of scenarios by applying the PER-based transmitted power trial, and more particularly, can judge the transmitted power is available given the PER satisfies the requirement(s). For example, the PER satisfies the requirements means the overall SNR is sufficient. To achieve the best coverage for a data rate, the wireless transceiver device can increase the TX power until the PER is lower than a target PER threshold. If there is no transmitted power having any low PER, this data rate will not be used. In addition, to achieve the availably low transmitted power for a specific data rate, the wireless transceiver device can try a lower TX power and check its PER, and can keep using the lower transmitted power given its PER satisfies the system requirement. As illustrated with the partial curve 210 shown in FIG. 2, the wireless transceiver device can control the TX power to be as high as possible for coverage extension; and as illustrated with the partial curve 220 shown in FIG. 2, the wireless transceiver device can control the TX power to be as low as possible for low power consumption.

In this embodiment, the curve corresponding to the coverage extension and the curve corresponding to the low power consumption may be illustrated as shown in the lower half part of FIG. 2 for better comprehension. This is for illustrative purposes only, and is not meant to be a limitation of the present invention. According to some embodiments, the curves respectively corresponding to the coverage extension and the low power consumption in the PER-based transmission power control scheme, the ranges and the scales of any curve among these curves along the horizontal and the vertical axes, the curve in the EVM-based transmission power control scheme, the ranges and the scales of this curve along the horizontal and the vertical axes, and/or the associated parameters may vary.

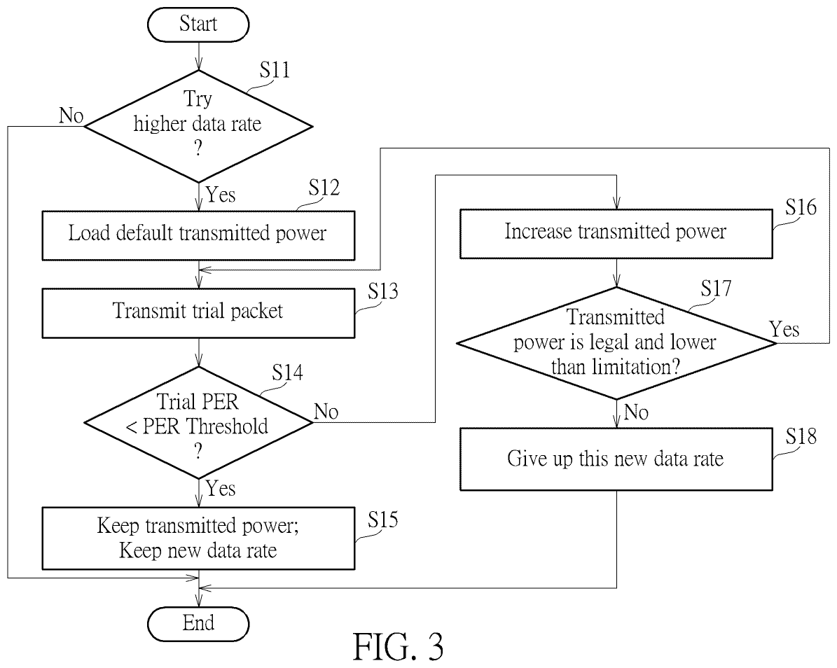

FIG. 3 illustrates a coverage extension control scheme of the method according to an embodiment of the present invention. The aforementioned any wireless transceiver device (e.g., the AP device 110 or the STA device 120) and another device (e.g., the STA device 120 or the AP device 110, or a peer AP device among multiple AP devices {110} that is similar to or the same as the AP device 110 or a peer STA device (or a peer non-AP STA device) among multiple STA devices {120} that is similar to or the same as the STA device 120) within the wireless communication system 100 can operate according to the working flow shown in FIG. 3.

In Step S11, the wireless transceiver device can try to find a higher data rate (e.g., any next data rate that is higher than the current data rate, if the aforementioned any next data rate exists), and more particularly, determine whether it is needed to switch to the higher data rate mentioned above (labeled “Try higher data rate” for brevity). If the determination result of Step S11 is positive (or Yes), Step S12 is entered; and if the determination result of Step S11 is negative (or No), the working flow shown in FIG. 3 comes to the end.

In Step S12, the wireless transceiver device can load the default transmitted power corresponding to the higher data rate (e.g., the aforementioned any next data rate, as determined recently in Step S11).

In Step S13, the wireless transceiver device can transmit a packet such as a trial packet with the default transmitted power (e.g., the default transmitted power that is just loaded in Step S12) to the other device, for the PER-based transmitted power trial. For example, the other device can monitor the PERs of the packets (e.g., the trial packet) from the wireless transceiver device, and return the PERs of the packets to the wireless transceiver device.

In Step S14, the wireless transceiver device can determine whether a trial PER such as the PER of the trial packet is less than a first predetermined threshold such as a first PER threshold (labeled “Trial PER<PER Threshold” for brevity). If the determination result of Step S14 is positive (or Yes), Step S15 is entered; and if the determination result of Step S14 is negative (or No), Step S16 is entered. For example, the first PER threshold may represent the target PER threshold mentioned above.

In Step S15, the wireless transceiver device can keep the transmitted power (e.g., the default transmitted power that is just loaded in Step S12) as the latest transmitted power, and keep the new data rate (e.g., the aforementioned any next data rate, as determined recently in Step S11) as the latest data rate, for transmitting one or more subsequent packets with the latest transmitted power at the latest data rate.

In Step S16, the wireless transceiver device can increase the transmitted power.

In Step S17, the wireless transceiver device can determine whether the transmitted power (e.g., the transmitted power as determined recently in Step S16) is legal and lower than a first predetermined limitation (e.g., a strict upper limit of the TX power). If the determination result of Step S17 is positive (or Yes), Step S13 is entered; and if the determination result of Step S17 is negative (or No), Step S18 is entered.

In Step S18, the wireless transceiver device can give up this new data rate.

For better comprehension, the coverage extension control scheme may be illustrated with the working flow shown in FIG. 3, but the present invention is not limited thereto. According to some embodiments, one or more steps may be added, deleted, or changed in the working flow shown in FIG. 3. For example, the wireless transceiver device can transmit one or more subsequent packets with the latest transmitted power (e.g., the transmitted power as determined or kept recently in Step S15, for the case that the partial working flow comprising at least Steps S12 to S15 (or even Steps S12 to S17) has been executed in response to the determination result “Yes” of Step S11, or the current TX power that is recently used before the execution of Step S21, for the case that the execution of the partial working flow comprising Steps S12 to S18 has been skipped in response to the determination result “No” of Step S11 or for the case that the partial working flow comprising at least Steps S12 to S14 and S16 to S18 has been executed in response to the determination result “Yes” of Step S11) to the other device at the last part (e.g., the partial working flow after execution of any step among Steps S15 and S18 as illustrated with the arrow toward the end) of the working flow shown in FIG. 3. For brevity, similar descriptions for these embodiments are not repeated in detail here.

TABLE 2

| MCS | Default TX Power (dBm) |
|---|---|
| 0 | 20 |
| 1 | 20 |
| 2 | 20 |
| 3 | 20 |
| 4 | 20 |
| 5 | 19 |
| 6 | 18.5 |
| 7 | 18 |
| 8 | 17 |
| 9 | 17 |
| 10 | 16 |
| 11 | 16 |

Table 2 illustrates an example of the respective default TX power of the modulation and coding schemes (MCSs), but the present invention is not limited thereto. According to some embodiments, the MCSs that are available and/or the respective default TX power of the MCSs may vary.

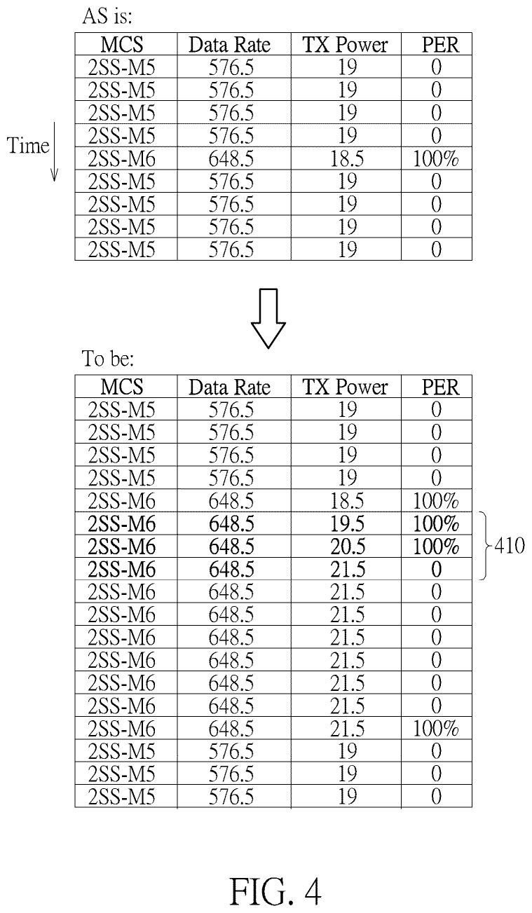

FIG. 4 illustrates, in the lower half part thereof, some implementation details of the coverage extension control scheme shown in FIG. 3 according to an embodiment of the present invention, where an example related to the EVM-based transmission power control scheme may be illustrated in the upper half part of FIG. 4 for better comprehension. Assume that one or more functions of the wireless communication system 100 may be temporarily disabled to allow the AP device 110 and the STA device 120 to operate according to the EVM-based transmission power control scheme as shown in the upper half part of FIG. 4, but the present invention is not limited thereto. Based on the EVM-based transmission power control scheme, as time goes by, the MCS may change among an MCS sequence {2SS-M5, . . . , 2SS-M5, 2SS-M6, 2SS-M5, . . . }, the data rate may change among a data rate sequence {576.5, . . . , 576.5, 648.5, 576.5, . . . }, the TX power may change among a TX power sequence {19, . . . , 19, 18.5, 19, . . . }, in unit of dBm, and the PER may change among a PER sequence {0, . . . , 0, 100%, 0, . . . }.

Based on the coverage extension control scheme, the aforementioned any wireless transceiver device (e.g., the AP device 110 or the STA device 120) can optimize the transmitted power in all kinds of scenarios by applying the PER-based transmitted power trial. As time goes by, the MCS may change among an MCS sequence {2SS-M5, . . . , 2SS-M5, 2SS-M6, 2SS-M6, 2SS-M6, 2SS-M6, 2SS-M6, . . . , 2SS-M6, 2SS-M5, . . . }, the data rate may change among a data rate sequence {576.5, . . . , 576.5, 648.5, 648.5, 648.5, 648.5, 648.5, . . . , 648.5, 576.5, . . . }, the TX power may change among a TX power sequence {19, . . . , 19, 18.5, 19.5, 20.5, 21.5, 21.5, . . . , 21.5, 19, . . . }, in unit of dBm, and the PER may change among a PER sequence {0, . . . , 0, 100%, 100%, 100%, 0, 0, . . . , 100%, 0, . . . }. The TX power sequence {19, . . . , 19, 18.5, 19.5, 20.5, 21.5, 21.5, . . . , 21.5, 19, . . . } with respect to the PER sequence {0, . . . , 0, 100%, 100%, 100%, 0, 0, . . . , 100%, 0, . . . } shown in the lower half part of FIG. 4 may be illustrated with the curve corresponding to the coverage extension as shown in FIG. 2. More particularly, the TX power sub-sequence {18.5, 19.5, 20.5, 21.5, 21.5, . . . } with respect to the PER sub-sequence {100%, 100%, 100%, 0, 0, . . . } as shown in the lower half part of FIG. 4 may be illustrated with the first rising partial curve (i.e., the rising partial curve prior to the partial curve 210) and the partial curve 210 as shown in FIG. 2. In addition, the wireless transceiver device (e.g., the AP device 110 or the STA device 120) can optimize the TX power by applying the PER-based transmitted power trial 410. For brevity, similar descriptions for this embodiment are not repeated in detail here.

According to some embodiments, the MCS, the data rate, the TX power and the PER in any control scheme among the coverage extension control scheme and the EVM-based transmission power control scheme as shown in FIG. 4 and/or the associated parameters may vary.

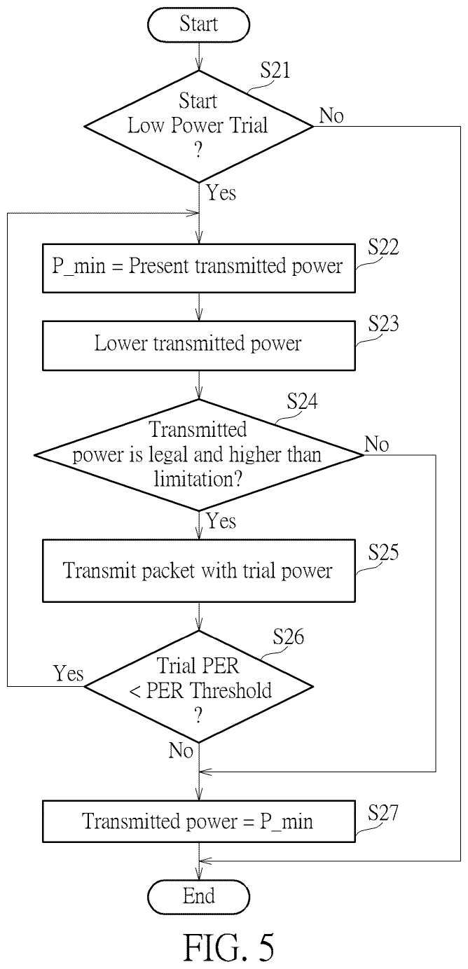

FIG. 5 illustrates a power consumption lowering control scheme of the method according to an embodiment of the present invention. The aforementioned any wireless transceiver device (e.g., the AP device 110 or the STA device 120) and the other device (e.g., the STA device 120 or the AP device 110, or the peer AP device that is similar to or the same as the AP device 110 or the peer STA device (or the peer non-AP STA device) that is similar to or the same as the STA device 120) within the wireless communication system 100 can operate according to the working flow shown in FIG. 5.

In Step S21, the wireless transceiver device can determine whether it is needed to start the low power trial, for trying to lower the power consumption. If the determination result of Step S21 is positive (or Yes), Step S22 is entered; and if the determination result of Step S21 is negative (or No), the working flow shown in FIG. 5 comes to the end.

In Step S22, the wireless transceiver device can set a minimum power P_min as being equal to the present transmitted power (labeled “P_min=Present transmitted power” for brevity). For example, if Step S22 is executed in response to the determination result “Yes” of Step S21, the present transmitted power may represent the current TX power that is recently used before the execution of Step S21; otherwise, in a situation where Step S22 is executed in response to the determination result “Yes” of Step S26, the present transmitted power may represent the latest TX power that is recently used in the loop comprising Steps S22 to S26.

In Step S23, the wireless transceiver device can lower the transmitted power to be a lower transmitted power, for being used as a trial power.

In Step S24, the wireless transceiver device can determine whether the transmitted power (e.g., the transmitted power as determined recently in Step S23, such as the lower transmitted power for being used as the trial power) is legal and higher than a second predetermined limitation (e.g., a strict lower limit of the TX power). If the determination result of Step S24 is positive (or Yes), Step S25 is entered; and if the determination result of Step S24 is negative (or No), Step S27 is entered.

In Step S25, the wireless transceiver device can transmit a packet with the trial power (e.g., the transmitted power as determined recently in Step S23) to the other device, for the PER-based transmitted power trial. For example, the other device can monitor the PERs of the packets (e.g., the packet with the trial power) from the wireless transceiver device, and return the PERs of the packets to the wireless transceiver device.

In Step S26, the wireless transceiver device can determine whether a trial PER such as the PER of the packet with the trial power is less than a second predetermined threshold such as a second PER threshold (labeled “Trial PER<PER Threshold” for brevity). If the determination result of Step S26 is positive (or Yes), Step S22 is entered; and if the determination result of Step S26 is negative (or No), Step S27 is entered. For example, the second predetermined threshold such as the second PER threshold in Step S26 may be equal to the first predetermined threshold such as the first PER threshold in Step S14, but the present invention is not limited thereto. In another example, the second predetermined threshold such as the second PER threshold in Step S26 may be different from the first predetermined threshold such as the first PER threshold in Step S14.

In Step S27, the wireless transceiver device can set the transmitted power as being equal to the minimum power P_min (labeled “Transmitted power=P_min” for brevity).

For better comprehension, the power consumption lowering may be illustrated with the working flow shown in FIG. 5, but the present invention is not limited thereto. According to some embodiments, one or more steps may be added, deleted, or changed in the working flow shown in FIG. 5. For example, the wireless transceiver device can transmit one or more subsequent packets with the latest transmitted power (e.g., the transmitted power as determined recently in Step S27, for the case that the partial working flow comprising Steps S22 to S27 has been executed in response to the determination result “Yes” of Step S21, or the current TX power that is recently used before the execution of Step S21, for the case that the partial working flow comprising Steps S22 to S27 has not been executed in response to the determination result “No” of Step S21) to the other device at the last part (e.g., the partial working flow after execution of Step S27 as illustrated with the arrow toward the end) of the working flow shown in FIG. 5. For brevity, similar descriptions for these embodiments are not repeated in detail here.

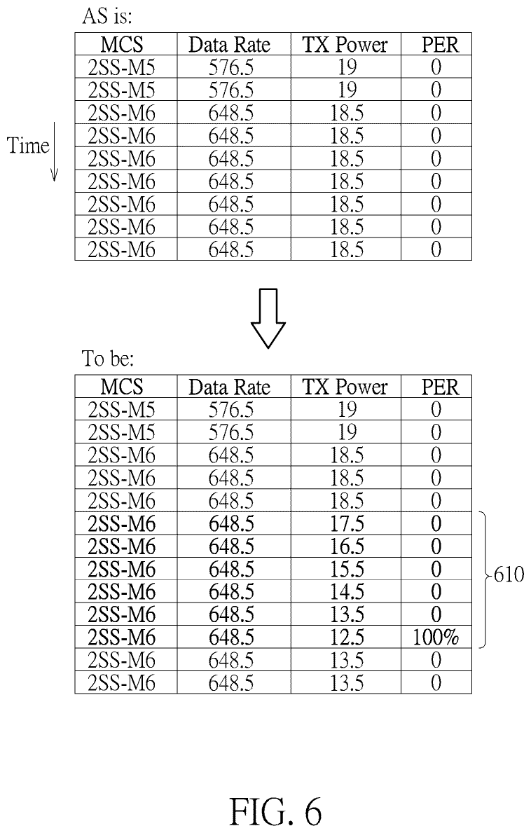

FIG. 6 illustrates, in the lower half part thereof, some implementation details of the power consumption lowering control scheme shown in FIG. 5 according to an embodiment of the present invention, where an example related to the EVM-based transmission power control scheme may be illustrated in the upper half part of FIG. 6 for better comprehension. Assume that one or more functions of the wireless communication system 100 may be temporarily disabled to allow the AP device 110 and the STA device 120 to operate according to the EVM-based transmission power control scheme as shown in the upper half part of FIG. 6, but the present invention is not limited thereto. Based on the EVM-based transmission power control scheme, as time goes by, the MCS may change among an MCS sequence {2SS-M5, 2SS-M5, 2SS-M6, . . . }, the data rate may change among a data rate sequence {576.5, 576.5, 648.5, . . . }, the TX power may change among a TX power sequence {19, 19, 18.5, . . . }, in unit of dBm, and the PER may keep the same or change among a PER sequence {0, 0, 0, . . . }.

Based on the power consumption lowering control scheme, the aforementioned any wireless transceiver device (e.g., the AP device 110 or the STA device 120) can optimize the transmitted power in all kinds of scenarios by applying the PER-based transmitted power trial. As time goes by, the MCS may change among an MCS sequence {2SS-M5, 2SS-M5, 2SS-M6, 2SS-M6, 2SS-M6, 2SS-M6, 2SS-M6, 2SS-M6, 2SS-M6, 2SS-M6, 2SS-M6, 2SS-M6, . . . }, the data rate may change among a data rate sequence {576.5, 576.5, 648.5, 648.5, 648.5, 648.5, 648.5, 648.5, 648.5, 648.5, 648.5, 648.5, . . . }, the TX power may change among a TX power sequence {19, 19, 18.5, 18.5, 18.5, 17.5, 16.5, 15.5, 14.5, 13.5, 12.5, 13.5, . . . }, in unit of dBm, and the PER may change among a PER sequence {0, 0, 0, 0, 0, 0, 0, 0, 0, 0, 100%, 0, . . . }. The TX power sequence {19, 19, 18.5, 18.5, 18.5, 17.5, 16.5, 15.5, 14.5, 13.5, 12.5, 13.5, . . . } with respect to the PER sequence {0, 0, 0, 0, 0, 0, 0, 0, 0, 0, 100%, 0, . . . } shown in the lower half part of FIG. 6 may be illustrated with the curve corresponding to the low power consumption as shown in FIG. 2. More particularly, the TX power sub-sequence {18.5, 17.5, 16.5, 15.5, 14.5, 13.5, 12.5, 13.5, . . . } with respect to the PER sub-sequence {0, 0, 0, 0, 0, 0, 100%, 0, . . . } as shown in the lower half part of FIG. 6 may be illustrated with the second V-shape partial curve (i.e., the V-shape partial curve prior to the partial curve 220) and the partial curve 220 as shown in FIG. 2. In addition, the wireless transceiver device (e.g., the AP device 110 or the STA device 120) can optimize the TX power by applying the PER-based transmitted power trial 610. For brevity, similar descriptions for this embodiment are not repeated in detail here.

According to some embodiments, the MCS, the data rate, the TX power and the PER in any control scheme among the power consumption lowering control scheme and the EVM-based transmission power control scheme as shown in FIG. 6 and/or the associated parameters may vary.

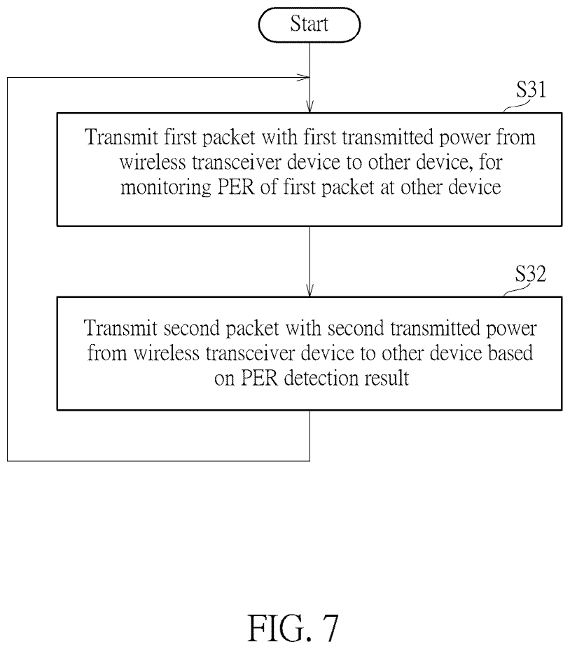

FIG. 7 illustrates a main working flow of the method according to an embodiment of the present invention. The aforementioned any wireless transceiver device (e.g., the AP device 110 or the STA device 120) and the other device (e.g., the STA device 120 or the AP device 110) within the wireless communication system 100 can operate according to the working flow shown in FIG. 7, but the present invention is not limited thereto. For example, if the wireless transceiver device is implemented as the AP device 110, the other device may be implemented as the STA device 120 such as a non-AP STA device or the peer AP device mentioned above; and if the wireless transceiver device is implemented as the STA device 120 such as a non-AP STA device, the other device may be implemented as the AP device 110 or the peer STA device (or the peer non-AP STA device) mentioned above.

In Step S31, the wireless transceiver device can transmit at least one first packet (e.g., the trial packet mentioned in Step S13 when Step S13 is executed for a first time, or the packet mentioned in Step S25 when Step S25 is executed for a first time) with at least one first transmitted power from the wireless transceiver device to the other device, for monitoring at least one PER (e.g., the trial PER mentioned in Step S14, or the trial PER mentioned in Step S26) of the aforementioned at least one first packet at the other device.

In Step S32, the wireless transceiver device can transmit a second packet (e.g., the trial packet mentioned in Step S13 when Step S13 is executed for a second time, or the packet mentioned in Step S25 when Step S25 is executed for a second time) with a second transmitted power from the wireless transceiver device to the other device based on a PER detection result, such as the PER detection result comprising any PER among the aforementioned at least one PER of the aforementioned at least one first packet.

Taking the working flow shown in FIG. 3 as an example, the aforementioned at least one first packet with the aforementioned at least one first transmitted power in Step S31 may represent the trial packet mentioned in Step S13 with the default transmitted power mentioned in Step S12 in any first iteration among at least one first iteration of the loop comprising Steps S13, S14, S16 and S17 as shown in FIG. 3, and the second packet with the second transmitted power in Step S32 may represent the trial packet mentioned in Step S13 with the default transmitted power mentioned in Step S12 in a second iteration of the same loop comprising Steps S13, S14, S16 and S17, or represent any subsequent packet that is transmitted to the other device at the end of the working flow shown in FIG. 3. According to some embodiments, the wireless transceiver device can transmit the second packet such as the aforementioned any subsequent packet to the other device at the last part (e.g., the partial working flow after execution of Step S15 as illustrated with the arrow toward the end) of the working flow shown in FIG. 3.

Taking the working flow shown in FIG. 5 as another example, the aforementioned at least one first packet with the aforementioned at least one first transmitted power in Step S31 may represent the packet mentioned in Step S25 with the trial power such as the lowered transmitted power as determined in Step S23 in any first iteration among at least one first iteration of the loop comprising Steps S22 to S26 as shown in FIG. 5, and the second packet with the second transmitted power in Step S32 may represent the packet mentioned in Step S25 with the trial power such as the lowered transmitted power as determined in Step S23 in a second iteration of the loop comprising Steps S22 to S26 as shown in FIG. 5, or represent any subsequent packet that is transmitted to the other device at the end of the working flow shown in FIG. 5. According to some embodiments, the wireless transceiver device can transmit the second packet such as the aforementioned any subsequent packet to the other device at the last part (e.g., the partial working flow after execution of Step S27 as illustrated with the arrow toward the end) of the working flow shown in FIG. 5.

For better comprehension, the method may be illustrated with the working flow shown in FIG. 7, but the present invention is not limited thereto. According to some embodiments, one or more steps may be added, deleted, or changed in the working flow shown in FIG. 7. For example, in the operation of Step S31, the wireless transceiver device can transmit the aforementioned at least one first packet (e.g., the trial packet mentioned in Step S13 when Step S13 is executed for the first time, or the packet mentioned in Step S25 when Step S25 is executed for the first time) with the aforementioned at least one first transmitted power from the wireless transceiver device to the other device, for monitoring the aforementioned at least one PER (e.g., the trial PER mentioned in Step S14, or the trial PER mentioned in Step S26) of the aforementioned at least one first packet at the other device, in order to obtain a transmitted power (TX power) sequence with respect to a PER sequence (e.g., the TX power sequence {19, . . . , 19, 18.5, 19.5, 20.5, 21.5, 21.5, . . . , 21.5, 19, . . . } with respect to the PER sequence {0, . . . , 0, 100%, 100%, 100%, 0, 0, . . . , 100%, 0, . . . } as shown in FIG. 4, or the TX power sequence {19, 19, 18.5, 18.5, 18.5, 17.5, 16.5, 15.5, 14.5, 13.5, 12.5, 13.5, . . . } with respect to the PER sequence {0, 0, 0, 0, 0, 0, 0, 0, 0, 0, 100%, 0, . . . } as shown in FIG. 6), for performing the PER-based transmitted power trial (e.g., the PER-based transmitted power trial 410 shown in FIG. 4, or the PER-based transmitted power trial 610 shown in FIG. 6). In addition, the wireless transceiver device can determine the second transmitted power mentioned in Step S32 according to at least one portion (e.g., a portion or all) of the TX power sequence with respect to the PER sequence. For example, regarding the coverage extension, the aforementioned at least one portion of the TX power sequence with respect to the PER sequence may comprise a first TX power sub-sequence with respect to a first PER sub-sequence, such as the TX power sub-sequence {18.5, 19.5, 20.5, 21.5, 21.5, . . . } with respect to the PER sub-sequence {100%, 100%, 100%, 0, 0, . . . } as shown in FIG. 4, where the first TX power sub-sequence with respect to the first PER sub-sequence carries a series of increasing TX power values, such as the series of increasing TX power values {18.5, 19.5, 20.5, 21.5}. In another example, regarding the power consumption lowering, the aforementioned at least one portion of the TX power sequence with respect to the PER sequence may comprise a second TX power sub-sequence with respect to a second PER sub-sequence, such as the TX power sub-sequence {18.5, 17.5, 16.5, 15.5, 14.5, 13.5, 12.5, 13.5, . . . } with respect to the PER sub-sequence {0, 0, 0, 0, 0, 0, 100%, 0, . . . } as shown in FIG. 6, where the second TX power sub-sequence with respect to the second PER sub-sequence carries a series of decreasing TX power values, such as the series of decreasing TX power values {18.5, 17.5, 16.5, 15.5, 14.5, 13.5, 12.5}. More particularly, the second TX power sub-sequence with respect to the second PER sub-sequence further carries a first subsequent TX power value (e.g., the TX power value of 13.5) coming after the series of decreasing TX power values (e.g., the series of decreasing TX power values {18.5, 17.5, 16.5, 15.5, 14.5, 13.5, 12.5}), where the first subsequent TX power value is greater than the last TX power value (e.g., the TX power value of 12.5) among the series of decreasing TX power values. The first subsequent TX power value such as the TX power value of 13.5 may be equal to a first one of last two TX power values (e.g., the TX power values {13.5, 12.5}) among the series of decreasing TX power values. Among the series of decreasing TX power values {18.5, 17.5, 16.5, 15.5, 14.5, 13.5, 12.5}, the last TX power value such as the TX power value of 12.5 is the second one of the last two TX power values such as the TX power values {13.5, 12.5}, and comes after the first one of the last two TX power values, such as the TX power value of 13.5. For brevity, similar descriptions for these embodiments are not repeated in detail here.

According to some embodiments,, for a first electronic product and a second electronic product of the same model that operate according to the method for implementing the wireless transceiver device, a first maximum transmitted power of the first electronic product and a second maximum transmitted power of the second electronic product may be different from each other. For brevity, similar descriptions for these embodiments are not repeated in detail here.

In the EVM-based transmission power control scheme, the transmitted power may be determined by the maximum transmitted power with the predefined transmitted EVM specification. However, this predefined transmitted EVM specification is typically the worst case with considering all kinds of channel effects, production variation, and receiver capability difference. Some EVM margin may be kept to suffer all kinds of variation. Thus, the transmitted power is fixed. However, if the receiver signal strength is much higher than the requirement, the excessive transmitted power will result in additional power consumption. In comparison with this, the aforementioned any wireless transceiver device (e.g., the AP device 110 or the STA device 120 such as the non-AP STA device) can optimize the transmitted power in all kinds of scenarios by applying the PER-based transmitted power trial. More particularly, if the required transmitted EVM have some margin to raise the transmitted power, the wireless transceiver device can raise the transmitted power to increase the receiver signal strength and observe the PER result. If the PER is low given raising the transmitted power, it means the degraded transmitted EVM is still good enough to achieve the higher data rate. If the receiver signal strength is higher than the requirement, the wireless transceiver device can perform the PER-based transmitted power trial to find the minimum transmitted power with sufficient receiver signal strength based on the PER result, and therefore can lower the transmitted power to reduce unnecessary power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing transmission power management of a wireless transceiver device within a wireless communication system with aid of packet-error-rate-based (PER-based) transmitted power trial, the method comprising:
transmitting at least one first packet with at least one first transmitted power from the wireless transceiver device to another device, for monitoring at least one packet error rate (PER) of the at least one first packet at the other device; and
transmitting a second packet with a second transmitted power from the wireless transceiver device to the other device based on a PER detection result, the PER detection result comprising any PER among the at least one PER of the at least one first packet.

2. The method of claim 1, wherein transmitting the at least one first packet with the at least one first transmitted power from the wireless transceiver device to the other device for monitoring the at least one PER of the at least one first packet at the other device further comprises:
transmitting the at least one first packet with the at least one first transmitted power from the wireless transceiver device to the other device, for monitoring the at least one PER of the at least one first packet at the other device, in order to obtain a transmitted power (TX power) sequence with respect to a PER sequence, for performing the PER-based transmitted power trial.

3. The method of claim 2, wherein the wireless transceiver device is arranged to determine the second transmitted power according to at least one portion of the TX power sequence with respect to the PER sequence.

4. The method of claim 2, wherein regarding coverage extension, the at least one portion of the TX power sequence with respect to the PER sequence comprises a first TX power sub-sequence with respect to a first PER sub-sequence, wherein the first TX power sub-sequence with respect to the first PER sub-sequence carries a series of increasing TX power values.

5. The method of claim 2, wherein regarding power consumption lowering, the at least one portion of the TX power sequence with respect to the PER sequence comprises a second TX power sub-sequence with respect to a second PER sub-sequence, wherein the second TX power sub-sequence with respect to the second PER sub-sequence carries a series of decreasing TX power values.

6. The method of claim 5, wherein the second TX power sub-sequence with respect to the second PER sub-sequence further carries a first subsequent TX power value coming after the series of decreasing TX power values, wherein the first subsequent TX power value is greater than a last TX power value among the series of decreasing TX power values.

7. The method of claim 6, wherein the first subsequent TX power value is equal to a first one of last two TX power values among the series of decreasing TX power values, wherein the last TX power value is a second one of the last two TX power values, and comes after the first one of the last two TX power values.

8. The method of claim 1, wherein the wireless transceiver device is implemented as an access point (AP) device or a non-access-point (non-AP) station (STA) device.

9. The method of claim 1, wherein:
if the wireless transceiver device is implemented as an access point (AP) device, the other device is implemented as a non-access-point (non-AP) station (STA) device or a peer AP device; and
if the wireless transceiver device is implemented as a non-AP STA device, the other device is implemented as an AP device or a peer non-AP STA device.

10. The method of claim 1, wherein for a first electronic product and a second electronic product of a same model that operate according to the method, a first maximum transmitted power of the first electronic product and a second maximum transmitted power of the second electronic product are different from each other.

11. A wireless transceiver device, for performing transmission power management of the wireless transceiver device within a wireless communication system with aid of packet-error-rate-based (PER-based) transmitted power trial, the wireless transceiver device comprising:
a processing circuit, arranged to control operations of the wireless transceiver device; and
at least one communication control circuit, coupled to the processing circuit, arranged to perform communication control, wherein the at least one communication control circuit is arranged to perform wireless communication operations for the wireless transceiver device; wherein:
the wireless transceiver device is arranged to transmit at least one first packet with at least one first transmitted power from the wireless transceiver device to another device, for monitoring at least one packet error rate (PER) of the at least one first packet at the other device; and
the wireless transceiver device is arranged to transmit a second packet with a second transmitted power from the wireless transceiver device to the other device based on a PER detection result, the PER detection result comprising any PER among the at least one PER of the at least one first packet.

12. The wireless transceiver device of claim 11, wherein the wireless transceiver device is arranged to transmit the at least one first packet with the at least one first transmitted power from the wireless transceiver device to the other device, for monitoring the at least one PER of the at least one first packet at the other device, in order to obtain a transmitted power (TX power) sequence with respect to a PER sequence, for performing the PER-based transmitted power trial.

13. The wireless transceiver device of claim 12, wherein the wireless transceiver device is arranged to determine the second transmitted power according to at least one portion of the TX power sequence with respect to the PER sequence.

14. The wireless transceiver device of claim 12, wherein regarding coverage extension, the at least one portion of the TX power sequence with respect to the PER sequence comprises a TX power sub-sequence with respect to a PER sub-sequence, wherein the TX power sub-sequence with respect to the PER sub-sequence carries a series of increasing TX power values.

15. The wireless transceiver device of claim 12, wherein regarding power consumption lowering, the at least one portion of the TX power sequence with respect to the PER sequence comprises a TX power sub-sequence with respect to a PER sub-sequence, wherein the TX power sub-sequence with respect to the PER sub-sequence carries a series of decreasing TX power values.

16. The wireless transceiver device of claim 15, wherein the TX power sub-sequence with respect to the PER sub-sequence further carries a first subsequent TX power value coming after the series of decreasing TX power values, wherein the first subsequent TX power value is greater than a last TX power value among the series of decreasing TX power values.

17. The wireless transceiver device of claim 16, wherein the first subsequent TX power value is equal to a first one of last two TX power values among the series of decreasing TX power values, wherein the last TX power value is a second one of the last two TX power values, and comes after the first one of the last two TX power values.

18. The wireless transceiver device of claim 11, wherein the wireless transceiver device is implemented as an access point (AP) device or a non-access-point (non-AP) station (STA) device.

19. The wireless transceiver device of claim 11, wherein:
if the wireless transceiver device is implemented as an access point (AP) device, the other device is implemented as a non-access-point (non-AP) station (STA) device or a peer AP device; and
if the wireless transceiver device is implemented as a non-AP STA device, the other device is implemented as an AP device or a peer non-AP STA device.

20. The wireless transceiver device of claim 11, wherein for a first electronic product and a second electronic product of a same model for implementing the wireless transceiver device, a first maximum transmitted power of the first electronic product and a second maximum transmitted power of the second electronic product are different from each other.
